(19) United States
(12) Patent Application Publication
(10) Pub. No.: US 2026/0236004 A1
(43) Pub. Date: Aug. 13, 2026

(54) NUMERICAL CONTROL DEVICE AND COMPUTER-READABLE STORAGE MEDIUM

(71) Applicant: Fanuc Corporation, Minamitsuru-gun, Yamanashi (JP)

(72) Inventor: Satoru SEKIKAWA, Minamitsuru-gun, Yamanashi (JP)

(73) Assignee: Fanuc Corporation, Minamitsuru-gun, Yamanashi (JP)

(21) Appl. No.: 19/160,531

(22) PCT Filed: Mar. 8, 2023
(86) PCT No.: PCT/JP2023/008730

§ 371 Date: Aug. 28, 2025

(51) Int. Cl. G05B 19/404; B23Q 15/12

(52) U.S. Cl. CPC G05B 19/404; B23Q 15/12

(57) ABSTRACT

Provided is a numerical control device that acquires a variation condition for periodically varying a spindle speed, computes the periodically varying spindle speed on the basis of a variation amplitude ratio and a variation frequency ratio included in the variation condition, acquires the temperature of the spindle, and, when the temperature of the spindle exceeds a predetermined temperature threshold value, reduces at least one of or both of the variation amplitude ratio and the variation frequency ratio.

### CROSS-REFERENCE TO RELATED APPLICATIONS

This is the U.S. National Phase application of PCT/JP2023/008730, filed on Mar. 8, 2023, the disclosure of which is incorporated herein by reference in its entirety for all purposes.

### FIELD OF THE INVENTION

The present disclosure relates generally to a numerical controller and a computer-readable storage medium.

### BACKGROUND OF THE INVENTION

Machining is a kind of removal processing for creating a desired shape on a workpiece to be processed by a relative movement between a tool and the workpiece. In a machine tool, a tool or a workpiece is attached to a spindle and then the spindle is rotated to do machining. During the machining, “regenerative chatter vibration” may occur. In the regenerative chatter vibration, the following phenomena occur repeatedly, i.e. vibrations occur on a cutting surface, cutting thickness becomes oscillatory due to the previous cut mark and the current cut mark, cutting force, which is proportional to the cutting thickness, becomes oscillatory, and the tool or workpiece is vibrationally excited.

For preventing the occurrence of regenerative chatter vibration, there is a conventional technique that changes a spindle speed into the form of a triangular or sinusoidal wave to thereby suppress the vibration in the cutting thickness. For example, Patent Literature 1 discloses such a technique.

### PATENT LITERATURE

[Patent Literature 1] PCT International Publication No. 2016/181450.

### BRIEF DESCRIPTION OF THE DRAWINGS

FIG. 1 is a block diagram of a numerical controller according to a first embodiment;

FIG. 2 is a schematic diagram showing a relationship between a variable frequency rate and a variable amplitude rate;

FIG. 3 is a flowchart illustrating an operation of the numerical controller according to the first embodiment;

FIG. 4 is a graph showing changes in the variable amplitude rate and the variable frequency rate in the first embodiment;

FIG. 5 is a graph showing changes in the variable amplitude rate and the variable frequency rate in a second embodiment;

FIG. 6 is a block diagram of a numerical controller according to a fourth embodiment;

FIG. 7 is a graph of a frequency spectrum of spindle vibration;

FIG. 8 is a flowchart illustrating an operation of the numerical controller according to the fourth embodiment;

FIG. 9 is a graph showing changes in a variable amplitude rate and a variable frequency rate in the fourth embodiment;

FIG. 10 is a block diagram of a numerical controller according to a fifth embodiment;

FIG. 11 is a block diagram of a numerical controller according to a sixth embodiment;

FIG. 12 is a flowchart illustrating an operation of the numerical controller according to the sixth embodiment;

FIG. 13 is a diagram of a screen display of the numerical controller according to the sixth embodiment; and

FIG. 14 is a hardware configuration diagram of the numerical controller.

### DETAILED DESCRIPTION

When the spindle speed is varied periodically, a load on a spindle motor increases, resulting in a rise in the temperature of the spindle motor. In order to avoid the rise in the temperature of the spindle motor, it is necessary to adjust variable amplitude/variable frequency of the spindle speed. The adjustment of the variable amplitude/variable frequency of the spindle speed is complicated.

Thus, there is a need for a technique to simplify the adjustment of the variable amplitude/variable frequency of the spindle speed.

According to the disclosure, an aspect of the present disclosure is a numerical controller that includes: a variation condition acquisition unit that acquires variation conditions for periodically varying spindle speed; a spindle speed computation unit that computes a vibrating spindle speed, which varies periodically, based on a variable amplitude rate and a variable frequency rate that are included in the variation conditions; a temperature acquisition unit that acquires temperature of a spindle; and a variation magnification computation unit that decreases one of or both the variable amplitude rate and the variable frequency rate when the temperature of the spindle exceeds a predefined temperature threshold value.

A numerical controller of the present disclosure has a function of suppressing regenerative chatter vibration. The regenerative chatter vibration is caused by roughness on a machining surface produced by the cutting conducted by a blade one before. When vibrations are generated on the machining surface in the cutting conducted by the blade one before, a cutting thickness becomes oscillatory due to a cutting mark left by the blade one before and a cutting mark left by this time. Consequently, cutting force that is proportional to the cutting thickness also becomes oscillatory, and thus a tool or workpiece is vibrationally excited.

The numerical controller is configured to suppress vibrations by periodically varying a spindle speed. The numerical controller according to the illustrative embodiment adjusts an amplitude and frequency variation ratio of the spindle speed. The larger the amplitude and the frequency of the spindle, the greater the effect of suppressing chatter vibration. However, a load on the spindle increases, and thus the temperature of the spindle rises. The numerical controller adjusts a variable frequency rate and a variable amplitude rate of the spindle speed, and calculates the variable frequency rate and the variable amplitude rate to control heating of the spindle and suppress the chatter vibration.

### First Embodiment

A description will now be made about a numerical controller according to a first embodiment.

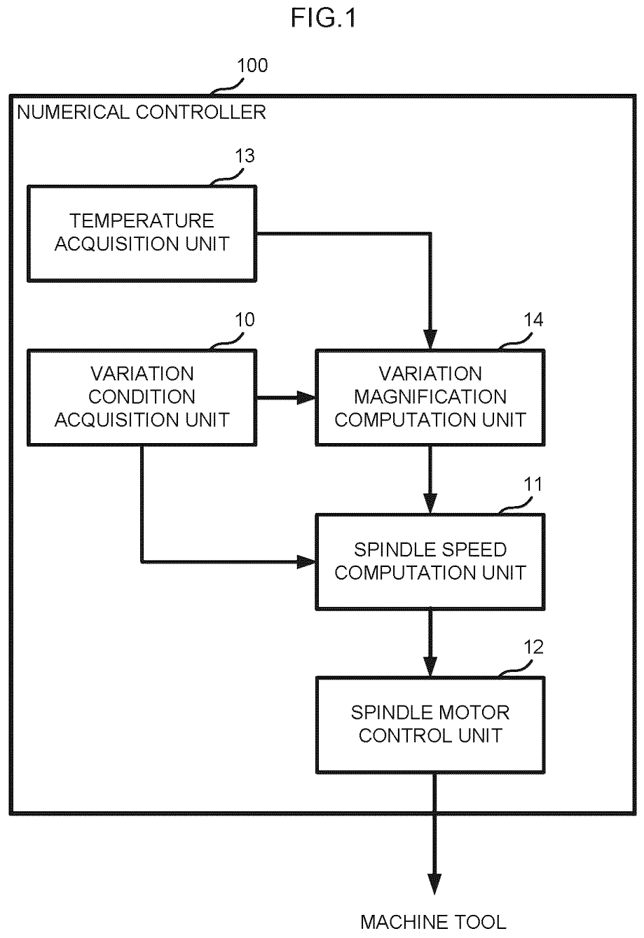

FIG. 1 is a block diagram of a numerical controller 100 according to the first embodiment. The numerical controller 100 includes a variation condition acquisition unit 10, a spindle speed computation unit 11, a spindle motor control unit 12, a temperature acquisition unit 13, and a variation magnification computation unit 14.

The variation condition acquisition unit 10 is configured to acquire variation conditions set for a spindle speed. The variation conditions include a variable amplitude rate initial value RVAᵢₙᵢₜ, a variable frequency rate initial value RVFᵢₙᵢₜ, and a temperature threshold value Tₜₕ. The variation conditions are input by a machine maker that is a user of a machine tool.

The spindle speed computation unit 11 is configured to calculate a spindle speed by the following formula based on the variation conditions and output the result of calculation to the spindle motor control unit 12. The spindle motor control unit 12 is configured to control a motor of the machine tool to rotate the motor at a designated spindle speed.

$$Ω = {Ω}_{0} \times RVA \times sin ( \frac{2 π N {Ω}_{0} \cdot RVF}{60} t ) \qquad ( 1 )$$

In the above formula, the term Ω₀ is a reference spindle speed, the term Ω is a spindle speed, the term RVA is a variable amplitude rate, and the term RVF is a variable frequency rate. The reference spindle speed Ω₀ is a speed of a spindle specified in a machining program. The spindle speed Ω is a periodically varied speed of the reference spindle speed Ω₀. The variable frequency rate RVF is a coefficient used for adjusting the frequency of the spindle speed. The variable amplitude rate is a coefficient used for adjusting the amplitude of the spindle speed.

The variable frequency rate initial value RVFᵢₙᵢₜ is an initial value of the variable frequency RVF. The variable amplitude rate initial value RVAᵢₙᵢₜ is an initial value of the variable amplitude rate RVA.

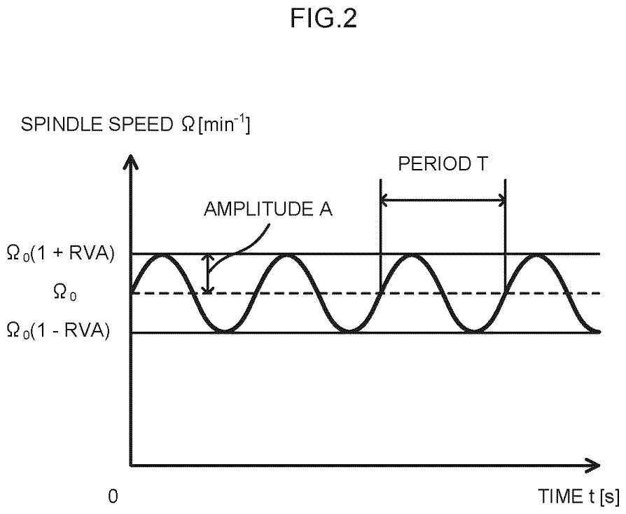

FIG. 2 shows a relationship between the variable frequency rate RVF and the variable amplitude rate RVA. The numerical controller 100 calculates the spindle speed Ω obtained by periodically varying the reference spindle speed Ω₀. By varying the spindle speed Ω periodically, the regenerative chatter vibration can be suppressed. The variable frequency rate RVF and the variable amplitude rate RVA are coefficients used for adjusting a frequency fₛ and an amplitude A, respectively, of the spindle speed Ω.

The following formula indicates a relationship between the variable frequency rate RVF, the variable amplitude rate RVA and the reference spindle speed

$$Frequency {f}_{s} = \frac{1}{T} Variable Frequency Rate RVF = \frac{60 {f}_{s}}{N {Ω}_{0}} Variable Amplitude Rate RVA = A / {Ω}_{0} \qquad ( 2 )$$

The temperature acquisition unit 13 is configured to acquire the temperature of the spindle. A method for acquiring the temperature is not limited to any specific method. The temperature of the spindle is related to the amplitude A and the frequency fₛ of the spindle speed Ω. The higher either the amplitude A or the frequency fₛ, the higher the spindle temperature.

The variation magnification computation unit 14 is configured to compare the temperature of the spindle with the temperature threshold value Tₜₕ, and when the temperature of the spindle exceeds the temperature threshold value Tₜₕ, decreases at least one of the variable frequency rate RVF and the variable amplitude rate RVA. The decrease of either the variable frequency rate RVF or the variable amplitude rate RVA can lower the temperature of the spindle. The variation magnification computation unit 14 determines to interrupt cutting when the temperature of the spindle is equal to or higher than the temperature threshold value Tₜₕ or to continue the cutting when the temperature is lower than the temperature threshold value Tₜₕ.

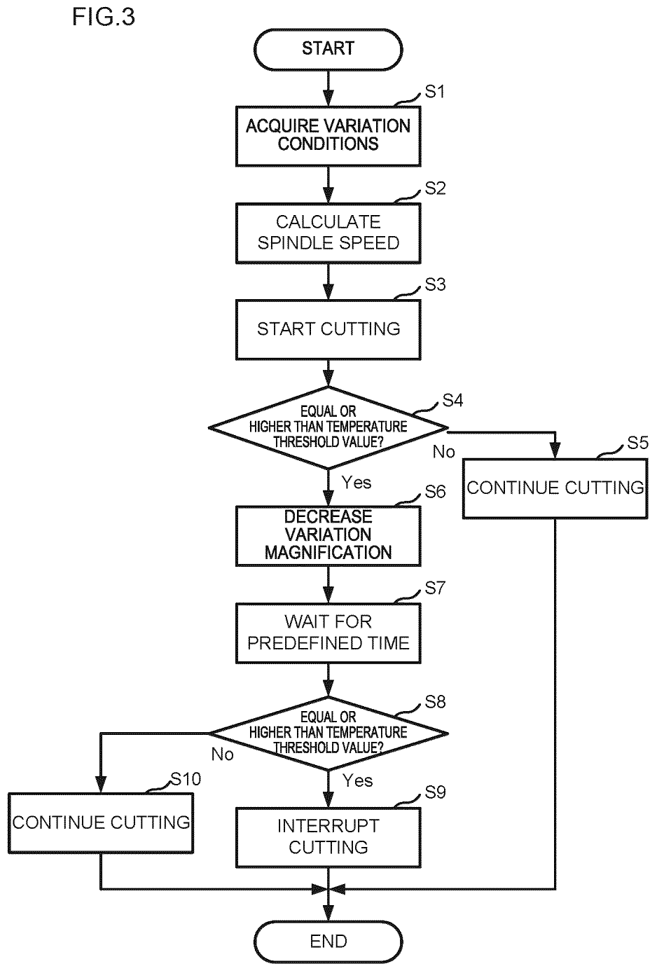

An operation of the numerical controller 100 of the first embodiment will be described by referring to a flowchart in FIG. 3.

First, the variation condition acquisition unit 10 acquires variation conditions (step S1). Then, the spindle speed computation unit 11 calculates a spindle speed based on a variation magnification (step S2). The initial variation magnifications are the variable amplitude rate initial value RVAᵢₙᵢₜ and the variable frequency rate initial value RVFᵢₙᵢₜ acquired by the variation condition acquisition unit 10.

An operator operates the numerical controller 100 to enable a machine tool to start cutting (step S3). The temperature acquisition unit 13 acquires the temperature of a spindle.

The variation magnification computation unit 14 compares the temperature of the spindle with the temperature threshold value Tₜₕ. When the temperature of the spindle is lower than the temperature threshold value Tₜₕ (step S4: No), the variation magnification computation unit 14 continues cutting without changing the variation magnification (step S5). When the temperature of the spindle is equal to or higher than the temperature threshold value Tₜₕ (step S4: Yes), the variation magnification computation unit 14 decreases the variation magnification (at least either the variable amplitude rate RVA or variable frequency rate RVF) (step S6).

The variation magnification computation unit 14 waits for a predefined time (step S7), and then compares the temperature of the spindle with the temperature threshold value Tₜₕ. When the temperature of the spindle is lower than the temperature threshold value Tₜₕ (step S8: No), the variation magnification computation unit 14 continues cutting (step S10). When the temperature of the spindle is equal to or higher than the temperature threshold value Tₜₕ (step S8: No), the variation magnification computation unit 14 interrupts cutting (step S9).

As described above, the numerical controller 100 according to the first embodiment acquires the temperature of the spindle, and decreases at least either the amplitude fₛ or the frequency A of the vibration of the spindle Ω when the temperature of the spindle exceeds the temperature threshold value Tₜₕ. The numerical controller 100 acquires the temperature of the spindle and continues cutting when the temperature of the spindle becomes lower than the temperature threshold value Tₜₕ, or interrupts cutting when the temperature of the spindle is higher than the temperature threshold value Tₜₕ. Thus, the variation magnification for periodic variation of the spindle speed Ω (variable amplitude rate RVA, variable frequency rate RVF) is adjusted automatically to thereby prevent the rise in the temperature of the spindle. The numerical controller 100 adjusts the temperature spindle automatically so that the burden on the operator is reduced.

### Second Embodiment

The numerical controller 100 according to a second embodiment decreases the variable amplitude rate RVA and the variable frequency rate RVF to their minimum values. The configuration of the numerical controller according to the second embodiment is much the same as that of the numerical controller according to the first embodiment, and thus a description will be made only about different functions in the configuration.

The variable condition acquisition unit 10 is configured to acquire a variable amplitude rate minimum value RVAₘᵢₙ and a variable frequency rate minimum value RVFₘᵢₙ, in addition to a variable amplitude rate initial value RVAᵢₙᵢₜ and a variable frequency rate initial value RVFᵢₙᵢₜ.

The variation magnification computation unit 14 is configured to compare a temperature of a spindle with a temperature threshold value Tₜₕ, and when the temperature of the spindle exceeds the temperature threshold value Tₜₕ, then decreases the variable frequency rate RVF to the variable frequency rate minimum value RVFₘᵢₙ or decreases the variable amplitude rate RVA to the variable amplitude minimum value RVAₘᵢₙ, or conducts both processes.

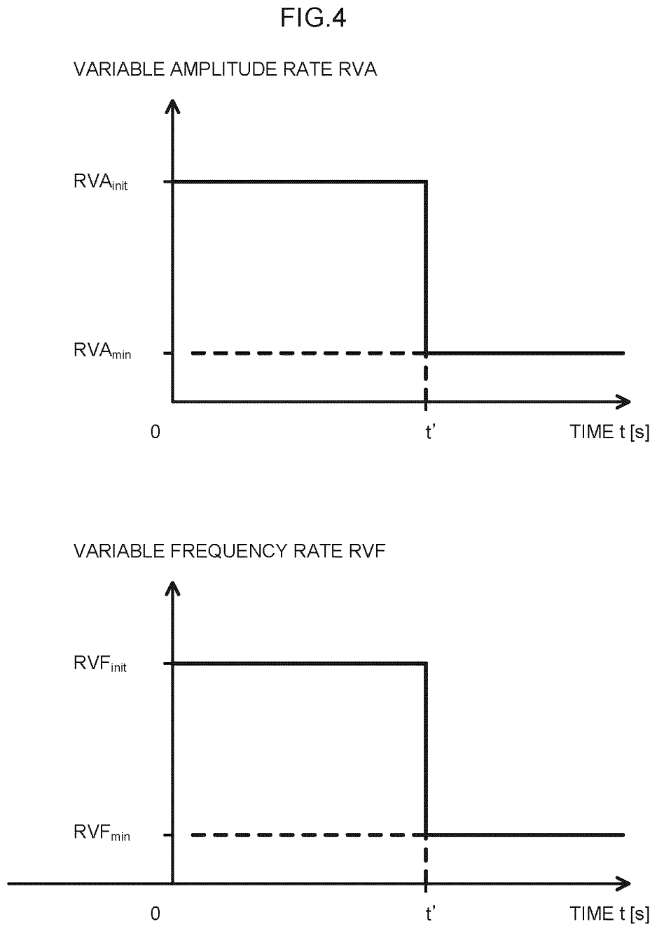

FIG. 4 shows changes in the variable amplitude rate RVA and the variable frequency rate RVF. The variation magnification computation unit 14 decreases the variation magnification to the minimum value at a time t′ the temperature of the spindle exceeds the temperature threshold value Tₜₕ. The decrease in the variation magnification is implemented in such a way that (1) the variable amplitude rate RVA is decreased from the variable amplitude rate initial value RVAᵢₙᵢₜ to the variable amplitude rate minimum value RVAₘᵢₙ, (2) the variable frequency rate RVF is decreased from the variable frequency rate initial value RVFᵢₙᵢₜ to the variable frequency rate minimum value RVFₘᵢₙ, or (3) both (1) and (2) are conducted.

The reduction of the variation magnification results in the decrease in the temperature of the spindle. The variation magnification computation unit 14 waits for the predefined time, and then interrupts cutting when the temperature of the spindle is equal to or higher than the temperature threshold value Tₜₕ even though the variation magnification is decreased, or continues cutting when the temperature of the spindle is not higher than the temperature threshold value Tₜₕ.

According to the numerical controller 100 of the second embodiment, a load on a spindle motor can be reduced quickly by decreasing the variation magnification to its minimum value at a time.

### Third Embodiment

The numerical controller 100 according to a third embodiment gradually decreases the variable amplitude rate RVA and the variable frequency rate RVF. The configuration of the numerical controller 100 according to the third embodiment is much the same as that of the numerical controller according to the first embodiment, and thus a description will be made only about different functions in the configuration.

The variable condition acquisition unit 10 is configured to acquire a variable amplitude rate inclination value RVA_{coef} and a variable frequency rate inclination value RVF_{coef}, in addition to a variable amplitude rate initial value RVAᵢₙᵢₜ, a variable frequency rate initial value RVFᵢₙᵢₜ, and a temperature threshold value Tₜₕ.

The variation magnification computation unit 14 is configured to compare a temperature of a spindle with the temperature threshold value Tₜₕ, and when the temperature of the spindle exceeds the temperature threshold value Tₜₕ, then decreases the variable frequency rate RVF or the variable amplitude rate RVA, or gradually decreases both rates.

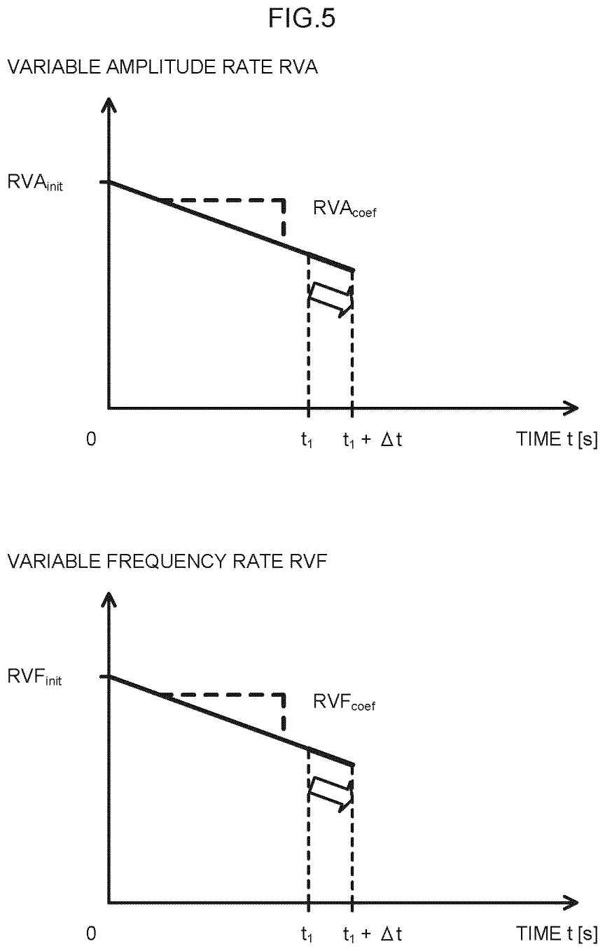

FIG. 5 shows changes in the variable amplitude rate RVA and the variable frequency rate RVF. The variation magnification computation unit 14 decreases a variation magnification for a predetermined time at a predetermined inclination at a time t′ the temperature of the spindle exceeds the temperature threshold value Tₜₕ. The decrease of the variation magnification is implemented in such a way that (1) the variable amplitude rate RVA is decreased for the predetermined time (called time Δt) at the variable amplitude rate inclination RVA_{coef}, (2) the variable frequency rate RVF is decreased for the predetermined time (called time Δt) at the variable frequency rate inclination RVF_{coef}, or (3) both (1) and (2) are conducted.

The decrease in the variation magnification results in the decrease in the temperature of the spindle. The variation magnification computation unit 14 interrupts cutting when the temperature of the spindle is equal to or higher than the temperature threshold value Tₜₕ even though the variation magnification is decreased, or continues cutting when the temperature of the spindle is not higher than the temperature threshold value Tₜₕ.

The numerical controller 100 of the third embodiment checks the change in the temperature of a spindle motor while decreasing the variation magnification, and stops decreasing the variation magnification when the temperature of the spindle motor is lowered sufficiently. According to the numerical controller 100 of the third embodiment, by stopping the decrease in the variation magnification when the temperature condition of the spindle motor is satisfied, the cutting can be continued at a larger variation magnification, thereby enhancing suppressing effect on the regenerative chatter vibration.

### Fourth Embodiment

The numerical controller 100 according to a fourth embodiment has a function of frequency analysis that adjusts the variable frequency rate RVF and the variable amplitude rate RVA while comparing regenerative chatter vibration with a predetermined threshold value, and calculates the variable frequency rate RVF and the variable amplitude rate RVA to suppress the regenerative chatter vibration to the predetermined threshold value and prevent the temperature of the spindle from exceeding the temperature threshold value Tₜₕ.

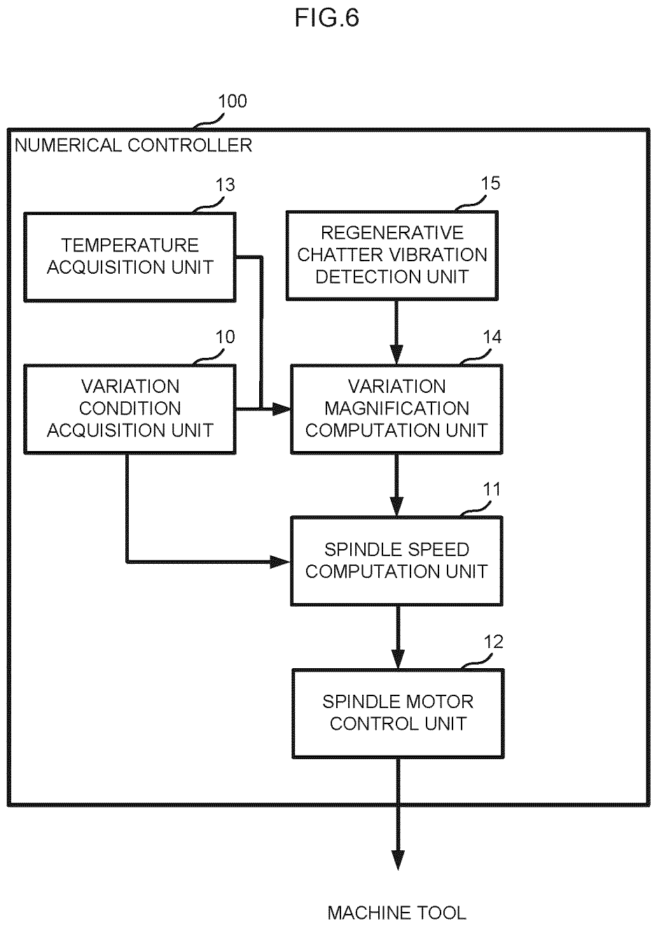

FIG. 6 is a block diagram of the numerical controller 100 according to the fourth embodiment. The numerical controller 100 of the fourth embodiment includes a regenerative chatter vibration detection unit 15. The configuration of the numerical controller 100 according to the fourth embodiment is much the same as that of the numerical controller according to the third embodiment, and thus a description will be made only about different functions in the configuration.

The variation condition acquisition unit 10 acquires a chatter vibration threshold value Kₜₕ (or formula for calculating chatter vibration threshold value Kₜₕ), in addition to a variable amplitude rate initial value RVAᵢₙᵢₜ, a variable frequency rate initial value RVFᵢₙᵢₜ, a temperature threshold value Tₜₕ, a variable amplitude rate inclination RVA_{coef}, and a variable frequency rate inclination RVF_{coef}.

The variation magnification computation unit 14 compares the temperature of the spindle with the temperature threshold value Tₜₕ, and when the temperature of the spindle is equal to or higher than the temperature threshold value Tₜₕ, gradually decreases the variable frequency rate RVF or the variable amplitude rate RVA, or both of them. The method of the gradual decrease is the same as that of the third embodiment and thus it will not be described in here.

The regenerative chatter vibration detection unit 15 is configured to detect regenerative chatter vibration. The regenerative chatter vibration can be detected by, for example, a method (1) that conducts spectrum analysis on a signal, such as cutting force, displacement, cutting noise and electric current, a method (2) that obtains a root-mean-square value of the above-mentioned signal, and a method (3) that employs machine learning, such as deep learning.

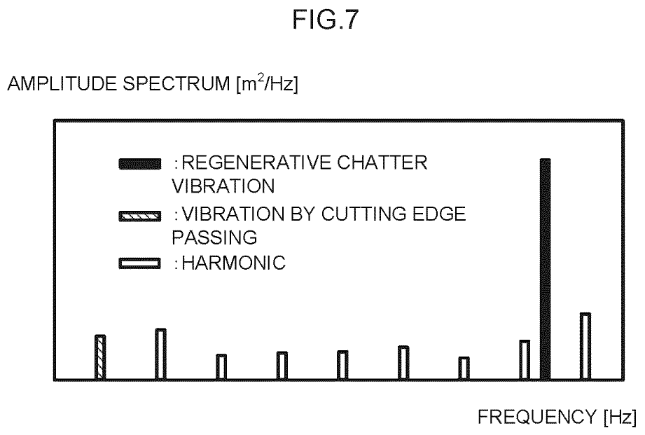

FIG. 7 shows an example of frequency spectra. The regenerative chatter vibration detection unit 15 conducts Fourier transform on the vibration of the spindle to acquire frequency spectra. In FIG. 7, the horizontal axis indicates frequencies, and the vertical axis indicates the spectra of amplitude corresponding to the frequencies. There is a complex mixture of many frequencies in the vibrations of a machine during cutting. A frequency analysis shows that frequency component of tool cutting edge passing and its hormonic component are strongly expressed. The frequency of the harmonic component is integral multiple of the frequency component of the cutting edge passing. The regenerative chatter vibration detection unit 15 determines strong vibrations other than vibrations caused by the cutting edge passing and harmonics as regenerative chatter vibrations.

The method obtaining the root-mean-square value of a signal obtains the root-mean-square value of the above-mentioned signal in a time domain, so as to calculate an effective value of the signal. Then, the magnitude of the level of the effective value can be determined to detect the occurrence of regenerative chatter vibrations.

The method using the deep learning creates a learning model that extracts the characteristics of the regenerative chatter vibrations from an input signal, and uses the learning model to detect a regenerative chatter signal generated in the input signal.

The variation magnification computation unit 14 determines the variable frequency rate RVF and the variable amplitude rate RVA for keeping the regenerative chatter signal to an acceptable level. In the above-described method of obtaining the root-mean-square value, the variable frequency rate RVF and the variable amplitude rate RVA are determined such that the effective value of the signal is made to be equal to or lower than the predetermined threshold value. In the method of using the deep learning, a learning model that determines whether the regenerative chatter signal is kept to the acceptable level or not, by way of example.

In the method of using the spectrum analysis, the amplitude of a regenerative chatter vibration acquired by the Fourier transform is compared with the chatter vibration threshold value Kₜₕ. The chatter vibration threshold value Kₜₕ represents an allowable limit of the regenerative chatter vibration. The chatter vibration threshold value Kₜₕ is a limit value that does not affect the cutting.

An example of the chatter vibration threshold value Kₜₕ will be given here. This example defines a calculation formula for the chatter vibration threshold value Kₜₕ. In the calculation formula, the chatter vibration threshold value Kₜₕ is coefficient multiples of the maximum amplitude of the harmonic of the frequency of the cutting edge passing. The variation magnification computation unit 14 selects the maximum amplitude of the harmonic from the amplitude spectra, and multiply the selected maximum value by a given coefficient to calculate the chatter vibration threshold value Kₜₕ.

The variation magnification computation unit 14 compares the chatter vibration threshold value Kₜₕ with the amplitude of the regenerative chatter vibration, and when the amplitude of the regenerative chatter vibration is smaller than the chatter vibration threshold value Kₜₕ, reduces the variation magnification. When the variation magnification (one of or both the variable amplitude rate RVA and the variable frequency rate RVF) is reduced, the amplitude of the regenerative chatter vibration increases gradually. The variation magnification computation unit 14 stops the reduction of the variation magnification when the amplitude of the regenerative chatter vibration reaches the chatter vibration threshold value Kₜₕ.

The variable amplitude rate RVA at the time the amplitude reaches the chatter vibration threshold value Kₜₕ is called a variable amplitude rate setting value RVAₛₑₜ, the variable frequency rate RVF at the time the amplitude reaches the threshold value Kₜₕ is called a variable frequency rate setting value RVFₛₑₜ.

The variation magnification computation unit 14 fixes the variation magnification to the setting value and continues cutting, and compares the temperature of the spindle with the temperature threshold value Tₜₕ. The variation magnification computation unit 14 continues cutting when the temperature of the spindle is lower than the temperature threshold value Tₜₕ, or interrupts cutting when the temperature of the spindle is equal to or higher than the temperature threshold value Tₜₕ.

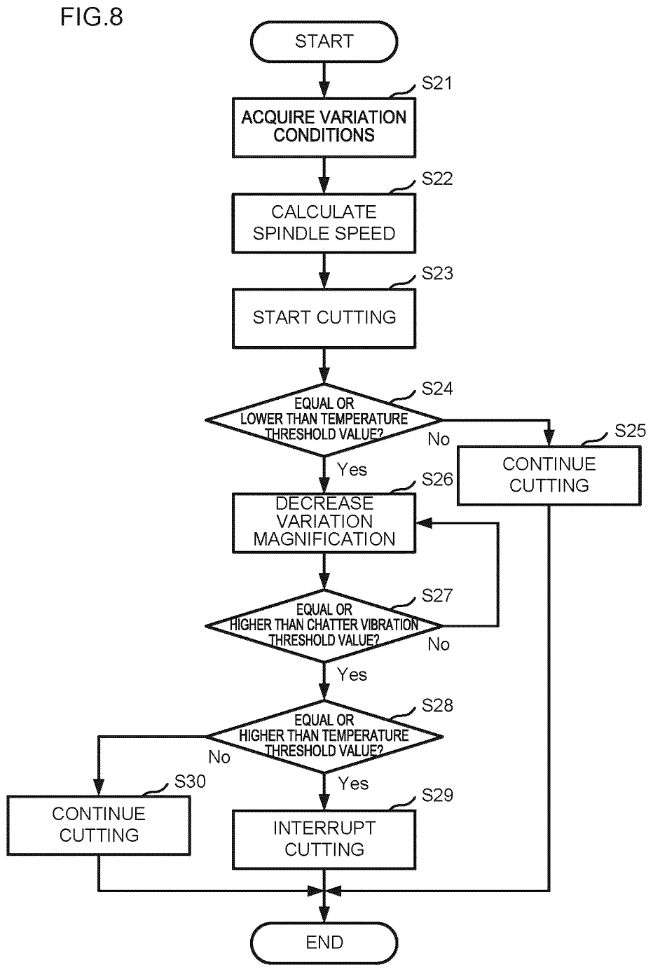

A description will be made about the operation of the numerical controller 100 according to the fourth embodiment by referring to the flowchart shown in FIG. 8. The flowchart illustrates a case where regenerative chatter vibrations are detected by a spectrum analysis. The method for detecting the regenerative chatter vibrations is not limited to the spectrum analysis.

First, the variation condition acquisition unit 10 acquires the variation conditions (step S21). Then, the spindle speed computation unit 11 calculates a spindle speed (step S22). Initial variation magnifications are the variable amplitude rate initial value RVAᵢₙᵢₜ and the variable frequency rate initial value RVFᵢₙᵢₜ acquired by the variation condition acquisition unit 10.

An operator operates the numerical controller 100 to allow the machine tool to start cutting (step S23). The temperature acquisition unit 13 acquires the temperature of the spindle.

The variation magnification computation unit 14 compares the temperature of the spindle with the temperature threshold value Tₜₕ. When the temperature of the spindle is lower than the temperature threshold value Tₜₕ (step S24: No), the variation magnification computation unit 14 continues cutting without changing the variation magnification (step S25). When the temperature of the spindle is equal to or higher than the temperature threshold value Tₜₕ (step S24: Yes), the variation magnification computation unit 14 reduces the variation magnification (at least either the variable amplitude rate RVA or the variable frequency rate RVF) (step S26).

The variation magnification computation unit 14 compares the amplitude of the regenerative chatter vibration with the chatter vibration threshold value Kₜₕ. When the amplitude of the regenerative chatter vibration is smaller than the chatter vibration threshold value Kₜₕ (step S27: No), the variation magnification computation unit 14 goes to the step S26 and reduces the variation magnification. The variation magnification computation unit 14 reduces the variation magnification as long as the amplitude of the regenerative chatter vibration does not exceed the chatter vibration threshold value Kₜₕ. When the amplitude of the regenerative chatter vibration is equal to or higher than the chatter vibration threshold value Kₜₕ (step S27: Yes), the variation magnification computation unit 14 sets the variation magnification within the range that does not exceed the chatter vibration threshold value Kₜₕ to the setting value of the variation magnification (variable amplitude rate setting value RVAₛₑₜ and variable frequency rate setting value RVFₛₑₜ).

The variation magnification computation unit 14 compares the temperature of the spindle with the temperature threshold value Tₜₕ. When the temperature of the spindle is equal to or higher than the temperature threshold value Tₜₕ (step S28: Yes), the variation magnification computation unit 14 interrupts cutting (step S29). When the temperature of the spindle is lower than the temperature threshold value Tₜₕ (step S28: No), the variation magnification computation unit 14 continues cutting (step S30).

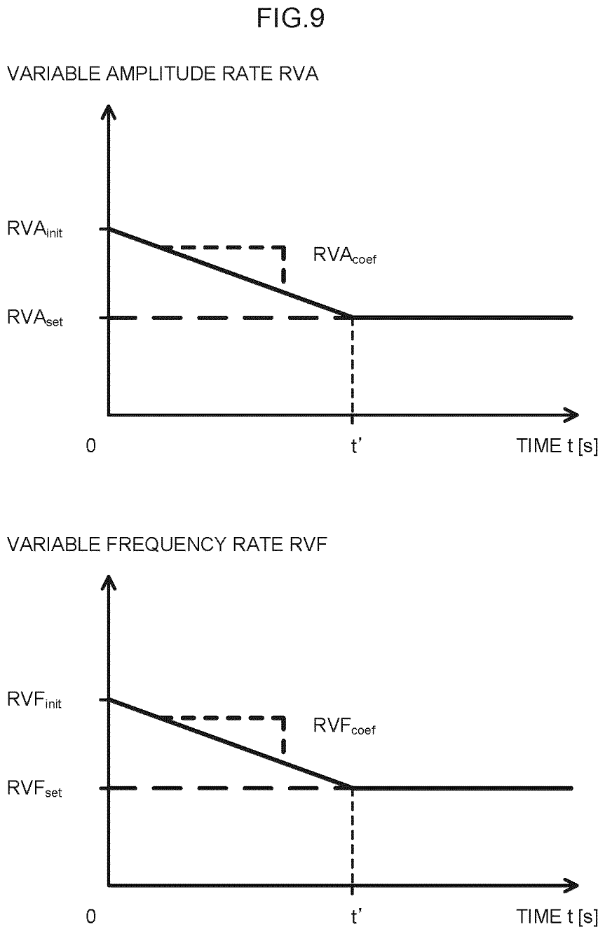

FIG. 9 shows the changes in the variable amplitude rate RVA and the variable frequency rate RVF in the fourth embodiment. First, a spindle speed Ω is calculated based on the variable amplitude rate initial value RVAᵢₙᵢₜ and the variable frequency rate initial value RVFᵢₙᵢₜ. When the temperature of the spindle at the time the spindle speed is varied based on the variable amplitude rate initial value RVAᵢₙᵢₜ and the variable frequency rate initial value RVFᵢₙᵢₜ is lower than the temperature threshold value Tₜₕ, the variation magnification computation unit 14 reduces the variation magnification. The variation magnification can be reduced by a method (1) that decreases the variable frequency rate RVF by a variable frequency rate inclination RVF_{coef}, a method (2) that decreases the variable amplitude rate RVA by a variable amplitude rate inclination RVA_{coef}, or a method (3) that conducts both the methods (1) and (2).

When the variation magnification is reduced, the amplitude of the regenerative chatter vibration increases gradually. Provided that a time t′ is the time when the amplitude of the regenerative chatter vibration exceeds the chatter vibration threshold value Kₜₕ, the variable frequency rate RVF and the variable amplitude rate RVA are fixed to the variable frequency rate setting value RVFₛₑₜ and the variable amplitude rate setting value RVAₛₑₜ, respectively.

The variation magnification computation unit 14 determines whether the temperature of the spindle exceeds the temperature threshold value Tₜₕ when the cutting is carried out with the variable frequency rate setting value RVFₛₑₜ and the variable amplitude rate setting value RVAₛₑₜ. According to the determination result, the cutting is continued when the temperature of the spindle does not exceed the temperature threshold value Tₜₕ, or the cutting is interrupted when the temperature of the spindle exceeds the temperature threshold value Tₜₕ.

The numerical controller 100 of the fourth embodiment enables the automatic search for the variable amplitude rate RVA and the variable frequency rate RVF that can keep the regenerative chatter vibration to the acceptable level and keep the temperature of the spindle to the acceptable level.

### Fifth Embodiment

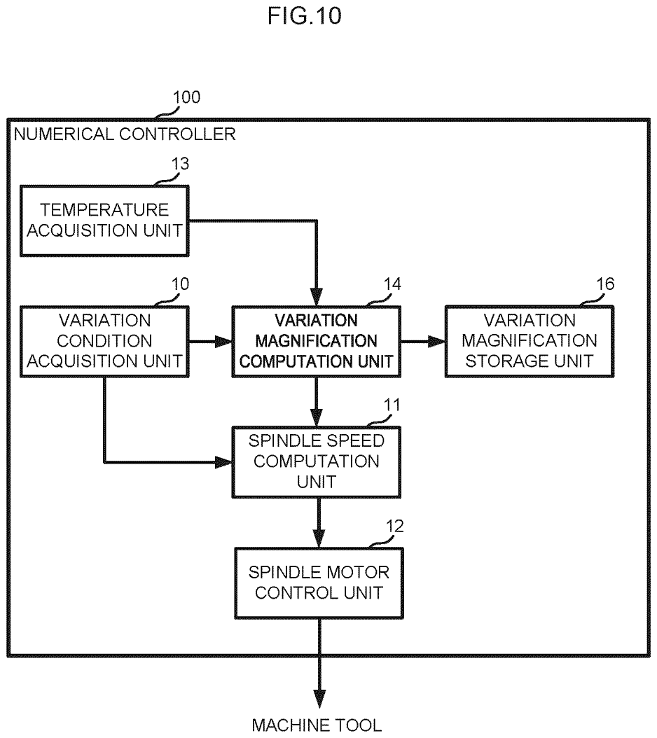

The numerical controller 100 according to a fifth embodiment stores a variation magnification calculated by the variation magnification computation unit 14 in association with blocks of the machining program. FIG. 10 is a block diagram of the numerical controller 100 according to the fifth embodiment. The numerical controller 100 of the fifth embodiment includes a variation magnification storage unit 16 that stores the blocks in the machining program in association with variation magnifications (variable amplitude rate and variable frequency rate). The configuration of the numerical controller according to the fifth embodiment is much the same as that of the numerical controller 100 according to the first embodiment, and thus a description will be made only about different functions in the configuration. The functions of the variation magnification storage unit 16 can be applied to the numerical controller 100 according to the second to fourth embodiments and the sixth embodiment.

According to the numerical controller 100 of the fifth embodiment, the blocks in the machining program are stored in association with the variation magnifications so that the variation magnification previously calculated during executing the concerned machining program can be used. It eliminates the need for readjustment of the variation magnification, and can reduce the physical load on the spindle and the computation load required to adjust the spindle speed.

### Sixth Embodiment

The numerical controller 100 according to a sixth embodiment displays variation magnifications when interrupting cutting and after the interruption of cutting as well as a change in the temperature of the spindle, and when the spindle is cooled down to a predefined setting value, resets the variation magnification and restarts cutting.

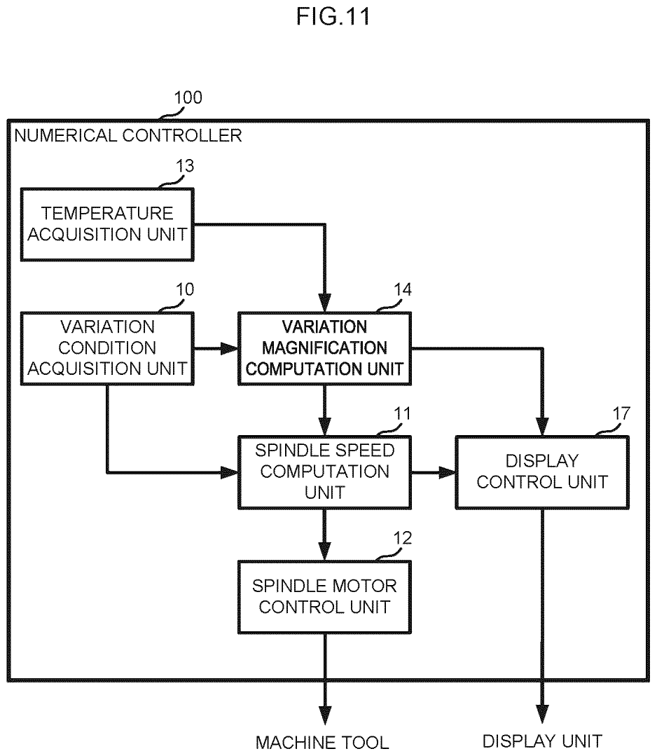

FIG. 11 is a block diagram of the numerical controller 100 according to the sixth embodiment. The numerical controller 100 of the sixth embodiment includes a display control unit 17. The configuration of the numerical controller 100 according to the sixth embodiment is much the same as that of the numerical controller 100 according to the first embodiment, and thus a description will be made only about different functions in the configuration. The functions of the numerical controller 100 of the sixth embodiment can be applied as functions after the interruption of cutting to the numerical controller 100 according to the first to fifth embodiments.

The display control unit 17 is configured to display on a display unit 70 at least the variable amplitude rates RVA, variable frequency rates RVF and the temperatures of the spindle when interrupting cutting and after the interruption of cutting by a graph and numerical values. The variable amplitude rate RVA, the variable frequency rate RVF and the temperature of the spindle may be displayed on the display unit 70 prior to the cutting is interrupted.

The variation magnification computation unit 14 compares the temperature of the spindle after the interruption of cutting with a predefined setting value, and when the temperature of the spindle is cooled down to the setting value, resets the variable amplitude rate RVA and the variable frequency rate RVF when interrupting cutting to the variable amplitude rate initial value RVAᵢₙᵢₜ and the variable frequency rate initial value RVFᵢₙᵢₜ.

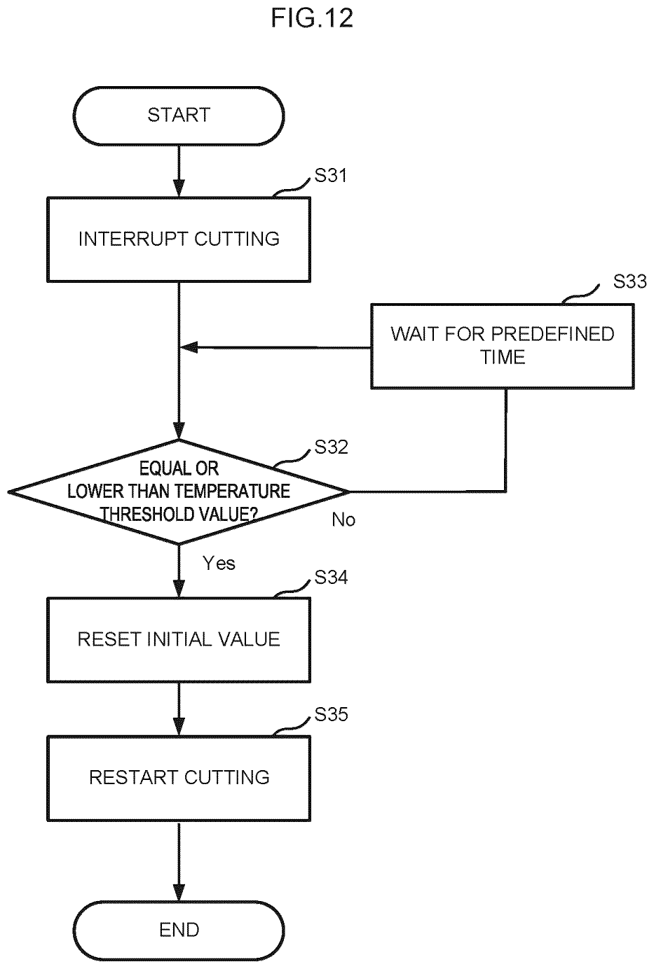

A description will be made about the operation of the numerical controller 100 of the sixth embodiment by referring to the flowchart shown in FIG. 12.

When the temperature of the spindle exceeds the temperature threshold value Tₜₕ, the variation magnification computation unit 14 interrupts cutting (step S31). After the interruption of cutting, the variation magnification computation unit 14 acquires the temperature of the spindle to determine whether the temperature of the spindle is equal to or lower than the predefined setting value. When the temperature of the spindle is higher than the predefined setting value (step S32: No), the variation magnification computation unit 14 waits for a predetermined time (step S33), and then compares the temperature of the spindle with the predefined setting value.

When the temperature of the spindle is equal to or lower than the predefined setting value (step S32: Yes), the variation magnification computation unit 14 resets the variable amplitude rate RVA and the variable frequency rate RVF when interrupting cutting to the variable amplitude rate initial value RVAᵢₙᵢₜ and the variable frequency rate initial value RVFᵢₙᵢₜ (step S34). The variation magnification computation unit 14 restarts cutting with the variable amplitude rate initial value RVAᵢₙᵢₜ and the variable frequency rate initial value RVFᵢₙᵢₜ thus reset (step S35).

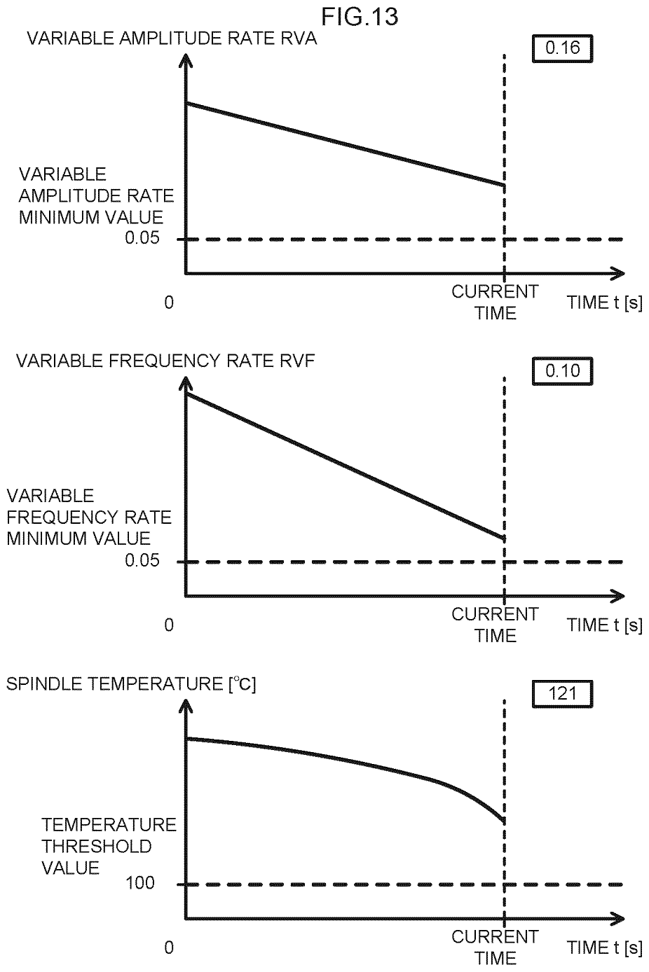

After the interruption of cutting, the display control unit 17 displays the graph and the numerical values of the variable amplitude rate RVA, the variable frequency rate RVF, and the temperature of the spindle on the display unit 70. FIG. 13 shows an example of a display screen that displays the changes in the variable amplitude rate RVA, the variable frequency rate RVF, and the temperature of the spindle when the interruption and the restart of the cutting are repeated. The variable amplitude rate RVA and the variable frequency rate RVF decrease gradually, and the variable amplitude rate RVA at the current time is “0.16” and the variable frequency rate RVF is “0.10”. The temperature of the spindle also decreases along with the changes in the variable amplitude rate RVA and the variable frequency rate RVF, and thus the temperature of the spindle at the current time is “121 degree centigrade”. The temperature of the spindle exceeds the temperature threshold value Tₜₕ, so that it is necessary to reset the variation conditions.

This display screen is an example of the display screen according to the second embodiment. The display screen displays the variable amplitude rate minimum value RVAₘᵢₙ and the variable frequency rate minimum value RVFₘᵢₙ. The display screen according to the third embodiment may display the variable amplitude rate inclination RVA_{coef} and the variable frequency rate inclination RVF_{coef}. The display screen according to the fourth embodiment may display the frequency components of the regenerative chatter vibration.

According to the numerical controller 100 of the sixth embodiment, after interrupting the cutting, the variable amplitude rate RVA and the variable frequency rate RVF when interrupting cutting are reset to the variable amplitude rate initial value RVAᵢₙᵢₜ and the variable frequency rate initial value RVFᵢₙᵢₜ. It enables the variation conditions to be set automatically.

Furthermore, in the numerical controller 100 of the sixth embodiment, the variable amplitude rate RVA, the variable frequency rate RVF and the temperature of the spindle after interrupting cutting are displayed on the display unit 70. Although the values of the variable amplitude rate RVA and the variable frequency rate RVF are automatically controlled, the values related to the control are displayed so that the operator can check the control status.

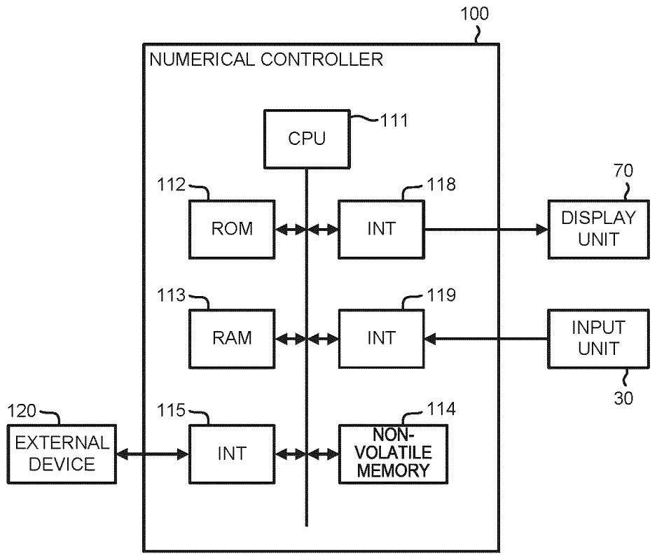

A description will now be made about a hardware configuration of the numerical controller 100 that applies the present disclosure. FIG. 14 is a hardware configuration diagram of the numerical controller 100. As shown in FIG. 14, the numerical controller 100 includes a central processing unit (CPU) 111 that is configured to control the entire numerical controller 100, a read-only memory (ROM) 112 that is configured to store programs and pieces of data, and a random-access memory (RAM) 113 on which pieces of data are temporarily loaded. The CPU 111 reads a system program stored in the ROM 112 via a bus and conducts preventing the occurrence of regenerative chatter vibration according to the system program.

A non-volatile memory 114 is backed up by a battery, not shown, for example, so that storage conditions can be retained even when a power source of the numerical controller 100 is turned off. The non-volatile memory 114 is configured to store programs read from an external device 120 via interfaces 115, 118 and 119 and various data about manipulated inputs and others entered through an input unit 30. The non-volatile memory 114 may store programs and pieces of data for implementing the numerical controller 100 of the illustrative embodiment. Furthermore, the display unit 70 is configured to display the various data, measurement results, factors of incorrect data, and the like.

The interface 115 is configured to connect the numerical controller 100 with the external device 120, such as an adaptor. From the external device 120, programs, various parameters and the like are read in.

The interface 118 is configured to connect the numerical controller 100 with the display unit 70, such as a liquid crystal display. The display unit 70 displays pieces of data read onto a memory, and data acquired as a result of the execution of the programs, by way of example.

The interface 119 is configured to connect the numerical controller 100 with the input unit 30, such as a keyboard or pointing device. The input unit 30 transfers commands, data and others produced based on manipulation by an operator to the CPU 111 via the interface 119.

The present disclosure has been described in detail, but is not limited to the above-described individual embodiments. Thus, various additions, substitutions, modifications, partial deletions and so on may be made to these embodiments without departing from the gist of the disclosure or the spirit of the disclosure as derived from the contents described in the appended claims and their equivalents. Furthermore, these embodiments can be implemented by combining them. For example, the order of the operations and the order of the processes in these embodiments are provided by way of example, and thus are not limited thereto.

Supplementary notes on the embodiments of the present disclosure and their variations will be presented below.

### Supplementary Note 1

A numerical controller (100) includes: a variation condition acquisition unit (10) that acquires variation conditions for periodically varying a spindle speed; a spindle speed computation unit (11) that computes a vibration spindle speed that fluctuates periodically based on a variable amplitude rate and a variable frequency rate included in the variation conditions; a temperature acquisition unit (13) that acquires a temperature of a spindle; and a variation magnification computation unit (14) that decreases one of or both the variable amplitude rate and the variable frequency rate when the temperature of the spindle exceeds a predefined temperature threshold value.

### Supplementary Note 2

After decreasing one of or both the variable amplitude rate and the variable frequency rate, the variation magnification computation unit (14) interrupts cutting when the temperature of the spindle exceeds a predefined temperature threshold value, or continues cutting when the temperature of the spindle does not exceed the predefined threshold value.

### Supplementary Note 3

The variable amplitude rate is a coefficient of an amplitude of the spindle speed, and the variable frequency rate is a coefficient of a frequency of the spindle speed.

### Supplementary Note 4

The variation condition acquisition unit (10) acquires one of or both a variable amplitude rate minimum value and a variable frequency rate minimum value, and when the temperature of the spindle exceeds the predefined temperature threshold value, the variation magnification computation unit (14) decreases the variable amplitude rate minimum value or the variable frequency rate minimum value, or decreases both of the minimum values.

### Supplementary Note 5

The variation condition acquisition unit (10) acquires one of or both a variable amplitude rate inclination and a variable frequency rate inclination, and when the temperature of the spindle exceeds the temperature threshold value, the variation magnification computation unit (14) decreases the variable amplitude rate by the variable amplitude rate inclination or the variable frequency rate by the variable frequency rate inclination, or decreases both of the rates.

### Supplementary Note 6

The numerical controller (100) includes a regenerative chatter vibration detection unit (15) that detects a regenerative chatter vibration, and the variation magnification computation unit (14) decreases one of or both the variable amplitude rate and the variable frequency rate until the regenerative chatter vibration falls to an acceptable level.

### Supplementary Note 7

The variation magnification computation unit (14) continues cutting by keeping the variable amplitude rate and the variable frequency rate at the time the amplitude of the regenerative chatter vibration reaches a predefined amplitude threshold value, and interrupts cutting when the temperature of the spindle exceeds the predefined temperature threshold value or continues cutting when the temperature of the spindle does not exceed the predefined threshold value.

### Supplementary Note 8

The numerical controller (100) includes a variation magnification storage unit (16) that stores, in association with blocks in a machining program, the variable amplitude rate and the variable frequency rate calculated when executing the block by the variation magnification computation unit (14) s.

### Supplementary Note 9

The variation magnification computation unit (14) waits, after interrupting cutting, until the temperature of the spindle decreases to a predefined setting value, then resets the variable amplitude rate and the variable frequency rate when interrupting cutting as respective initial values, and restarts cutting.

Supplementary Note 10

The numerical controller (100) includes a display control unit (17) that displays changes in the variable amplitude rate and the variable frequency rate on a display unit.

### Supplementary Note 11

A computer-readable storage medium (112, 113, 114) stores commands that allow one or more processors (111) to: acquire variation conditions for periodically varying a spindle speed; computes the spindle speed varying periodically based on a variable amplitude rate and a variable frequency rate that are included in the variation conditions; acquire temperature of a spindle; and decrease at least one of or both the variable amplitude rate and the variable frequency rate when the temperature of the spindle exceeds a predefined temperature threshold value.

1. A numerical controller, comprising:
a variation condition acquisition unit that acquires variation conditions for periodically varying a spindle speed;
a spindle speed computation unit that computes a vibrating spindle speed, which varies periodically, based on a variable amplitude rate and a variable frequency rate that are included in the variation conditions;
a temperature acquisition unit that acquires temperature of a spindle; and
a variation magnification computation unit that decreases one of or both the variable amplitude rate and the variable frequency rate when the temperature of the spindle exceeds a predefined temperature threshold value.

2. The numerical controller according to claim 1, wherein the variation magnification computation unit decreases one of or both the variable amplitude rate and the variable frequency rate, and then interrupts cutting when the temperature of the spindle exceeds the predefined temperature threshold value, or continues cutting when the temperature of the spindle does not exceed the predefined threshold value.

3. The numerical controller according to claim 1, wherein the variable amplitude rate is a coefficient of an amplitude of the spindle speed, and the variable frequency rate is a coefficient of a frequency of the spindle speed.

4. The numerical controller according to claim 1, wherein the variation condition acquisition unit acquires one of or both a minimum value of the variable amplitude rate and a minimum value of the variable frequency rate, and
when the temperature of the spindle exceeds the predefined temperature threshold value, the variation magnification computation unit decreases the variable amplitude rate to its minimum value or decreases the variable frequency rate to its minimum value, or decreases both of the rates to their minimum values.

5. The numerical controller according to claim 1, wherein the variation condition acquisition unit acquires one of or both a variable amplitude rate inclination and a variable frequency rate inclination, and
when the temperature of the spindle exceeds the predefined temperature threshold value, the variation magnification computation unit decreases the variable amplitude rate by the variable amplitude rate inclination or decreases the variable frequency rate by the variable frequency rate inclination, or decreases both of the rates.

6. The numerical controller according to claim 1, comprising a regenerative chatter vibration detection unit that detects a regenerative chatter vibration, wherein
the variation magnification computation unit decreases one of or both the variable amplitude rate and the variable frequency rate until the regenerative chatter vibration falls to an acceptable level.

7. The numerical controller according to claim 6, wherein the variation magnification computation unit continues cutting by keeping the variable amplitude rate and the variable frequency rate at the time amplitude of the regenerative chatter vibration reaches a predefined amplitude threshold value, and interrupts cutting when the temperature of the spindle exceeds the predefined temperature threshold value or continues cutting when the temperature of the spindle does not exceed the predefined threshold value.

8. The numerical controller according to claim 1, comprising a variation magnification storage unit that stores, in association with blocks of a machining program, the variable amplitude rate and the variable frequency rate calculated by the variation magnification computation unit when executing the blocks.

9. The numerical controller according to claim 2, wherein after interrupting cutting, the variation magnification computation unit waits until the temperature of the spindle decreases to a predefined setting value, and then resets the variable amplitude rate and the variable frequency rate when interrupting cutting as respective initial values to restart cutting.

10. The numerical controller according to claim 9, comprising a display control unit that displays changes in the variable amplitude rate and the variable frequency rate on a display unit.

11. A computer-readable storage medium that stores commands that allow one or more processors to:
acquire variation conditions for periodically varying a spindle speed;
compute the spindle speed, which varies periodically, based on a variable amplitude rate and a variable frequency rate that are included in the variation conditions;
acquire temperature of a spindle; and
decrease at least one of or both the variable amplitude rate and the variable frequency rate when the temperature of the spindle exceeds a predefined temperature threshold value.
